(19) United States
(12) Patent Application Publication
(10) Pub. No.: US 2025/0136424 A1
(43) Pub. Date: May 1, 2025

(54) SYSTEMS AND METHODS FOR LEAK DETECTION AND RESOLUTION IN A BEVERAGE DISPENSING SYSTEM

(71) Applicant: Hydration Labs, Inc., Charlestown, MA (US)

(72) Inventors: Chad Woodrow, Somerville, MA (US); David Skocypec, Charlestown, MA (US); Tim Fu, Charlestown, MA (US); Arumugam Jeganathan, Chelsea, MA (US); Corbin Basler, Charlestown, MA (US)

(21) Appl. No.: 18/926,805

(22) Filed: Oct. 25, 2024

Related U.S. Application Data
(60) Provisional application No. 63/593,631, filed on Oct. 27, 2023.

(51) Int. Cl. B67D 1/08; G01M 3/28

(52) U.S. Cl. CPC B67D 1/0878; G01M 3/2876

(57) ABSTRACT

Systems, methods, and devices for automated leak detection and resolution in a beverage dispensing system. A first signal associated with a peak dispensation pressure during beverage dispensation may be received, and after a time threshold, a second signal associated with a recovery dispensation pressure may be received. A malfunction, such as a leak, may be determined based on a difference between the first signal and the second signal exceeding a predetermined threshold. Automated reseating of the dispensation valve may be initiated to resolve the malfunction. Continuous monitoring and automated correction of leaks without requiring manual intervention are provided, improving reliability and reducing operational downtime in beverage dispensing systems.

### CROSS-REFERENCE TO RELATED APPLICATIONS

This application claims the benefit of, and priority to, U.S. Provisional Patent Application No. 63/593,631, filed Oct. 27, 2023, and entitled “SYSTEMS AND METHODS FOR LEAK DETECTION AND RESOLUTION IN A BEVERAGE DISPENSING SYSTEM,” the disclosure of which is hereby incorporated by reference herein in its entirety as if set forth herein.

### TECHNICAL FIELD

This application generally relates to systems and methods for leak detection and resolution and more specifically to leak detection and resolution in a manifold of a beverage dispensing system.

### BACKGROUND

Beverage dispensing systems are commonly used to deliver mixed drinks to consumers, often incorporating various liquids and syrups to create a customized beverage. The beverage dispensing systems may include a manifold structure with one or more valves that control the flow of the various liquids and syrups. Over time, leaks may develop in the valves due to wear, improper sealing, or mechanical failure, leading to inconsistent beverage quality and potential wastage.

Current methods for identifying and repairing leaks in beverage dispensing systems are largely manual, requiring a technician to physically inspect and diagnose the system. This process may be time-consuming and costly, particularly in large commercial environments where downtime may lead to significant operational disruption. Furthermore, manual diagnostics often involve disassembling parts of the system, which introduces risk of further mechanical issues and extended periods of system unavailability.

Therefore, there is a long-felt but unresolved need for a system or method that automatically identifies, diagnoses, and resolves leaks in beverage dispensing systems remotely and without intrusive repair techniques.

### SUMMARY

Briefly described, and in various embodiments, the present disclosure generally relates to systems, methods, and apparatuses for automated leak detection and resolution in a beverage dispenser (e.g., a beverage dispensing system). According to some aspects, the disclosed system and methods may include various computing systems and sensors designed to measure a system pressure of the beverage dispenser, determine the presence of a leak based on the system pressure, and/or remotely initiate a leak resolution process.

For example, on a newly deployed beverage dispenser, there may be leaks associated with one or more unused valves. When initially dispensing a particular beverage, a seal of one or more unused valves may be improperly seated within the valve and cause various types of leaks. The disclosed system may constantly monitor the pressure of the beverage dispensing system to identify the valves that are experiencing leaks and deploy the leak resolution process to adequately seat the seals within the valves.

For the purpose of explaining the functionality of the disclosed systems and methods, discussed herein is an example application of the particular disclosed systems and methods. Under normal operational circumstances, beverage dispensation may result in a decrease in the system pressure within the beverage dispensing system. Once the beverage dispensing system has completed dispensing the beverage, the system pressure may return to a baseline pressure following the closure of valves and disengagement of a beverage pump. In the presence of a leak, a dynamic pressure profile of the beverage dispensing system may change. In some instances, the system pressure may fail to recover to a pressure above a predetermined threshold. By systematically monitoring the system pressure before, during, and after dispensations, a beverage dispensing system may employ various sensors to automatically diagnose the presence, severity, and location of leaks.

Further, in some circumstances, leaks may be resolved by implementing the leak resolution process. The leak resolution process may include a series of brief rapid pressure changes in the beverage dispensing system. A computing system of the beverage dispenser may cause the series of brief rapid pressure changes by generating and transmitting a command to rapidly pulse the beverage pump during a short duration of time without opening dispensation valves. The computing system may employ the leak resolution process to repair leaks in some circumstances. By dynamically monitoring the system pressure as it changes in response to dispensation, and engaging leak repair mechanisms in cases where leaks are identified, beverage dispensing systems may be improved to remedy leaks that would otherwise require human intervention.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates an example environment for a beverage dispensing system, according to various aspects of the present disclosure;

FIG. 2 illustrates an example pressure profile according to various aspects of the present disclosure;

FIG. 3 illustrates a flowchart of a process according to various aspects of the present disclosure;

FIG. 4 illustrates a flowchart of a process according to various aspects of the present disclosure;

FIG. 5 illustrates an example beverage dispensing system, according to various aspects of the present disclosure;

FIG. 6 illustrates an example pressure profile for a non-leaking beverage dispensing system according to various aspects of the present disclosure;

FIG. 7 illustrates an example pressure profile for a leaking beverage dispensing system according to various aspects of the present disclosure;

FIG. 8 illustrates an example pressure profile for a beverage dispensing system exhibiting a major leak according to various aspects of the present disclosure;

FIG. 9 illustrates an exemplary process for leak detection and/or resolution in a beverage dispensing system according to various aspects of the present disclosure;

FIG. 10 illustrates an example schematic of a device according to various aspects of the present disclosure; and

FIG. 11 illustrates an example diagrammatic representation of a machine in the form of a computer system according to various aspects of the present disclosure.

### DETAILED DESCRIPTION

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

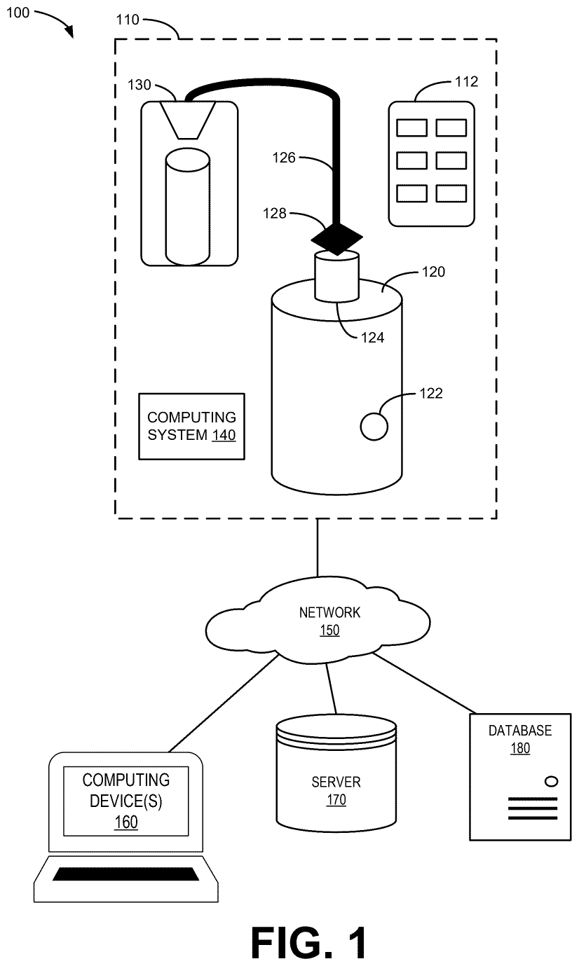

Referring now to the figures, for the purposes of example and explanation of processes and components of the disclosed systems and processes, reference is made to FIG. 1, which illustrates an exemplary environment 100 for a beverage dispensing system 110. As will be understood and appreciated, the beverage dispensing system 110 shown in FIG. 1 represents merely one approach or embodiment of the present concept, and other aspects may be used according to various embodiments of the present concept.

The beverage dispensing system 110 may be any particular beverage dispenser capable of creating a particular mixed drink. The beverage dispensing system 110 may include various flavored syrups and various liquids. The beverage dispensing system 110 may combine one or more of the flavored syrups with at least one of the various liquids to create the particular mixed drink. For example, the beverage dispensing system 110 may include a lime-coconut flavored syrup. Continuing this example, the beverage dispensing system 110 may mix the lime-coconut flavored syrup with carbonated water to create a carbonated lime-coconut beverage.

The beverage dispensing system 110 may include a user interface 112. The user interface 112 may be a set of buttons, a touch screen, or any other suitable input device that may interface with the beverage dispensing system 110. For example, the user interface 112 may include a cellular device that may wirelessly connect to the beverage dispensing system 110 (e.g., through Bluetooth, Wi-Fi, internet, Zigbee, Near Field Communication, etc.) and may control the functionalities of the beverage dispensing system 110. The user interface 112 may display beverage options for selection. Beverage options may include drink flavors, temperatures, and levels of carbonation. For example, the user interface 112 may include multiple types of flavor selections (e.g., strawberry, lime, peach, blueberry, raspberry, and/or flavorless), various temperature selections (e.g., hot, cold, cool, ambient, etc.), and various types of liquids (e.g., water, carbonated water, spring water, liquor, etc.).

The beverage dispensing system 110 may include a buffer tank 120. The buffer tank 120 may hold any particular liquid of the beverage dispensing system 110. For example, the buffer tank 120 may hold the desired beverage liquid (e.g., water, carbonated water), the flavoring for the particular beverage, or a combination thereof.

The buffer tank 120 may include a pressure sensor 122. The pressure sensor 122 may measure the pressure of the liquid in the buffer tank 120. The buffer tank 120 may be connected to a beverage pump 124. The pressure sensor 122 may be disposed downstream of the buffer tank 120 and upstream of the beverage pump 124. The pressure sensor 122 may rapidly detect a leak within the beverage dispensing system 110 when disposed downstream of the buffer tank 120 and upstream of the beverage pump 124.

The beverage pump 124 may pump the desired liquid for dispensation. For example, when a particular user makes a beverage selection through the user interface 112, the beverage dispensing system 110 may employ the beverage pump 124 to pump the desired liquid in combination with the flavored syrup through a dispensing apparatus 130. The beverage pump 124 may be connected to the dispensing apparatus 130 by a beverage conduit 126.

The beverage conduit 126 may be controlled by one or more beverage valves 128. For example, the one or more beverage valves 128 may include a manifold configuration used to combine various types of beverage liquids with various types of flavored syrups. Though illustrated on the exterior, all the components of the beverage dispensing system 110 may be embedded on or within the beverage dispensing system 110. For example, the buffer tank 120, the sensor 122, the valves 128, the beverage pump 124, and the beverage conduit 126 may be stored within the beverage dispensing system 110. Continuing this example, both the user interface 112 and/or the dispensing apparatus 130 may be embedded on or within the exterior surface of the beverage dispensing system 110.

The beverage dispensing system 110 may include a computing system 140. The computing system 140 may include any particular computing architecture capable of performing computational requirements for the beverage dispensing system 110. For example, the computing system 140 may include a microcontroller, a microprocessor, a processor system, a graphics card, a server computer, a laptop, a built-in personal computer, and/or any other particular device capable of performing computational analyses for the beverage dispensing system 110. The computing system 140 may perform calculations, store data in a data store, send data to remote computing servers, receive data through wired or wireless communications, and/or perform any particular functionality typical to like devices. The computing system 140 may communicate, control, and/or manage the valves 128, the pressure sensor 122, the user interface 112, and/or any particular device associated with the beverage dispensing system 110.

According to some aspects, the environment 100 may include a network 150 that allows communication between various components, such as the beverage dispensing system 110 and other connected devices. The network 150 may encompass a wide range of connection types, including wired, wireless, and cloud-based technologies. Moreover, the network 150 may include local area networks (LAN), wide area networks (WAN), the internet, or any combination thereof. This network 150 may facilitate transmission of data from the beverage dispensing system 110 to one or more computing devices 160, a server 170, and/or a database 180 for remote monitoring, control, and data storage purposes. Through the network 150, the beverage dispensing system 110 may send real-time system diagnostics, such as pressure sensor readings, leak detection alerts, and system performance data, to external systems for analysis and further action.

The one or more computing device(s) 160 may be configured to interact with the beverage dispensing system 110 through the network 150. The one or more computing device(s) 160 may include personal computers, mobile devices, tablets, or dedicated control terminals. Moreover, the one or more computing device(s) 160 may allow users or technicians to access and manage system settings, monitor operational status, and/or receive alerts. The computing device(s) 160 may communicate with a central server 170, which may act as a hub for managing multiple beverage dispensing systems, storing configuration settings, and/or executing maintenance protocols. The server 170 may also be linked to a database 180, where historical data, such as pressure logs, detected leaks, and repair histories, may be stored for future reference and system optimization. The database 180 may further be used for predictive maintenance, allowing the beverage dispensing system 110 to anticipate potential failures based on accumulated operational data.

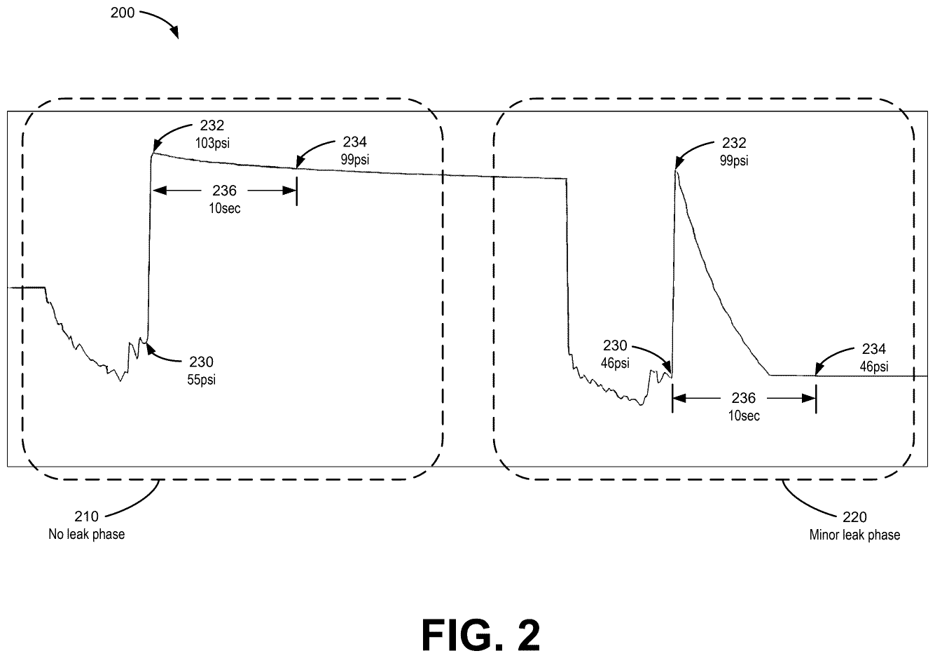

Referring now to FIG. 2, illustrated is an example pressure profile 200, according to one aspect of the present disclosure. The example pressure profile 200 may include a no-leak phase 210 and a minor leak phase 220. The computing system 140 may generate and/or analyze the pressure profile 200 based on readings gathered from the pressure sensor 122.

During the no-leak phase 210, the computing system 140 may measure a P₁ pressure 230, e.g., 55 pounds per square inch (psi). The P₁ pressure 230 may correspond to the pressure of the buffer tank 120 prior to the end of the dispensation. The computing system 140 may subsequently measure a P₂ pressure 232 (e.g., 103 psi) and a P₃ pressure 234 (e.g., 99 psi). The computing system 140 may measure the P₃ pressure 234 after a time period 236 (e.g., ten seconds) after measuring the P₂ pressure 232. In a normal functioning beverage dispensing system 110, the difference between the P₂ pressure 232 and the P₃ pressure 234 may measure less than a 5% difference. The computing system 140 may determine if there is a leak in the beverage dispensing system 110 if there is a difference in the P₂ pressure 232 and P₃ pressure 234 greater than the 5% difference.

For example, in the minor leak phase 220, the computing system 140 may measure a particular P₁ pressure 230 of 46 psi, corresponding to the pressure of the buffer tank 120 prior to the end of the dispensation. As further illustrated in the example of FIG. 2, the computing system 140 may measure a particular P₂ pressure 232 of 99 psi and, after a time period 236 of 10 seconds, the computing system 140 may measure a particular P₃ pressure 234 of 46 psi. Based on a measured difference of 56% between the P₂ pressure 232 and the P₃ pressure 234 being greater than a threshold, the computing system 140 may determine that the valves 128 are experiencing a minor leak. The computing system 140 may determine the severity of the leak by the size of the measured difference between the P₂ pressure 232 and the P₃ pressure 234. For example, the computing system 140 may determine a full leak if the difference between the P₂ pressure 232 and the P₃ pressure 234 is greater than 75%.

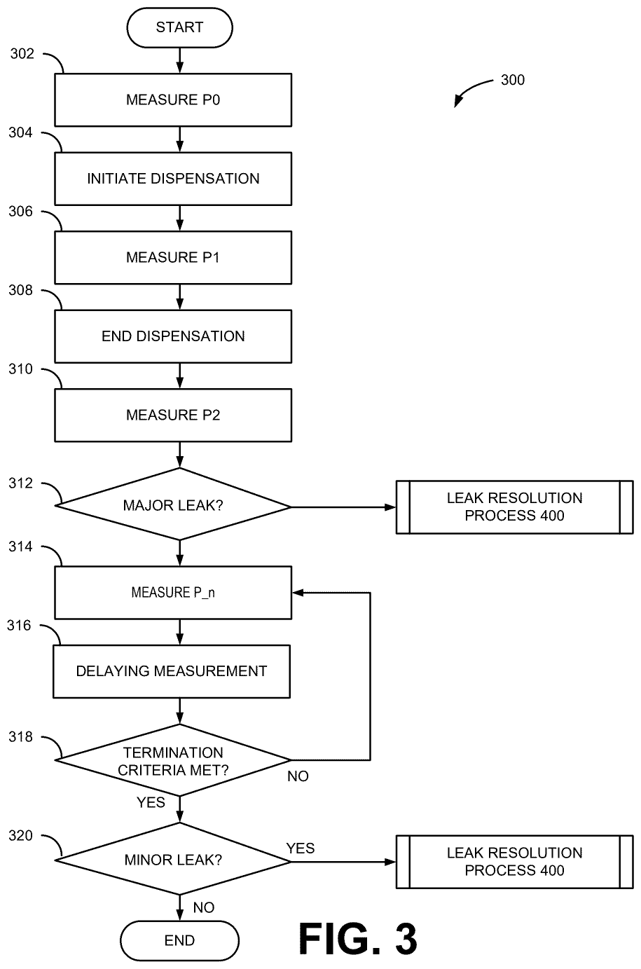

Referring now to FIG. 3, illustrated is a flowchart of a process 300, according to one example of the disclosed technology. The process 300 may illustrate a technique for achieving leak detection and mitigation within the beverage dispensing system 110. The process 300 may be performed by the various components of the beverage dispensing system 110.

At box 302, the process 300 may include measuring an initial pressure P₀ through the pressure sensor 122. The computing system 140 may measure the initial pressure P₀ of the buffer tank 120 through the pressure sensor 122. The computing system 140 may measure through the pressure sensor 122 the initial pressure P₀ prior to dispensing any particular liquid from the beverage dispensing system 110. The initial pressure P₀ may quantify a baseline pressure of the buffer tank 120. The computing system 140 may store the initial pressure P₀ for subsequent analysis and comparison.

At box 304, the process 300 may include initiating a beverage dispensation. The computing system 140 may initiate the dispensing of a particular beverage into a container. For example, the beverage dispensing system 110 may receive from the user interface 112 a request to dispense a particular mixed drink. On receiving the request from the user interface 112, the computing system 140 may open one or more of the beverage valves 128 and engage the beverage pump 124. The computing system 140 may continually activate the valves 128 and engage the beverage pump 124 for a predetermined period of time (e.g., 5 seconds). In some aspects, the computing system 140 may continually activate the valves 128 and engage the beverage pump 124 for a period of time determined by the user (e.g., the user may press a ‘pour’ button on a touchscreen for as long as desired).

At box 306, the process 300 may include a second pressure P₁. The computing system 140 may employ the pressure sensor 122 to measure the second pressure P₁. The measurement of P₁ may occur at a predetermined time relative to the end of the dispensation. For example, the pressure sensor 122 may measure P₁ one second prior to the end of the dispensation. In some embodiments, P₁ may be the minimum pressure measured during the duration of the dispensation. The computing system 140 may continually record the readings from the pressure sensor 122. On completion of dispensing the particular drink, the computing system may reference a pressure reading from the pressure sensor 122 one second prior to the completion of dispensation and record the pressure reading as the second pressure P₁.

At box 308, the process 300 may include ending the dispensation. The computing system 140 may end the dispensation of the particular beverage dispensing system 110. The computing system 140 may end the dispensation of the particular beverage dispensing system 110 by turning off the beverage pump 124 and closing beverage valves 128. The computing system may close any remaining valves within the system to create a closed system which facilitates the direct measurements of any pressure drops absent external influences.

At box 310, the process 300 may include measuring a third pressure P₂ through the pressure sensor 122. The computing system 140 may measure the third pressure P₂ through the pressure sensor 122. The computing system 140 may measure the third pressure P₂ within a particular time from the end of dispensation (e.g., within 1 second, 2 seconds, 3 seconds, 4 seconds, and/or a combination thereof).

At box 312, the process 300 may include determining if a major leak is detected. The computing system 140 may determine if a major leak is detected. The computing system 140 may determine the presence of the leak based on the relationship between the initial pressure P₀, the second pressure P₁, and the third pressure P₂. For example, if the third pressure P₂ at the end of the dispensation falls below a particular threshold pressure relative to the initial pressure P₀ (e.g., 80% below the initial pressure P₀), the computing system 140 may determine that a major leak is detected. In the event of a major leak, the computing system 140 may initiate a leak resolution process 400.

At step 314, the process 300 may include measuring additional pressure measurements (P₃, P₄, P₅, etc.) through the pressure sensor 122. In one embodiment, the computing system 140 may determine P₃ to be the minimum pressure in a time window (e.g., 2 seconds) following the measurement of P₂. The computing system 140 may make additional pressure measurements through the pressure sensor 122. The computing system 140 may continually take additional pressure measurements to determine the severity of the leak, determine whether or not the leak still persists, and determine whether or not to reactivate the leak resolution process 400.

At box 316, the process 300 may include delaying the measurement of each particular additional pressure measurement recorded by the press or sensor 122. The computing system 140 may include a time delay between each subsequent collection of the additional pressure measurements. For example, the computing system 140 may measure each additional pressure measurement in intervals of 1 second. The computing system 140 may continue to take additional pressure measurements through the pressure sensor 122 until a termination criteria is met at box 318. The termination criteria may be a number of additional pressure measurements, a length of time, or a feature of the measured pressure. For example, the termination criteria may include determining that a last pressure measurement Pₙ is equivalent to the initial pressure measurement P₀.

At box 320, the process 300 may include determining whether or not a minor leak is present. The computing system 140 may make a determination as to whether or not a minor leak is present. Though discussed sequentially, the detection of the minor leak at box 320 may occur at box 312, and/or vice-versa (e.g., the detection of a major leak may occur at box 324). The detection of a major leak and a minor leak may occur simultaneously in both boxes 312 and 320. The computing system 140 may determine the presence of a minor leak based on the additional pressure measurements measured subsequently to dispensing the particular beverage. For example, if the additional pressure measurements decrease by a certain percentage (e.g., 5%) relative to the third pressure P₂, the computing system 140 may identify a minor leak. If a minor leak is detected, the computing system 140 may enter leak resolution process 400.

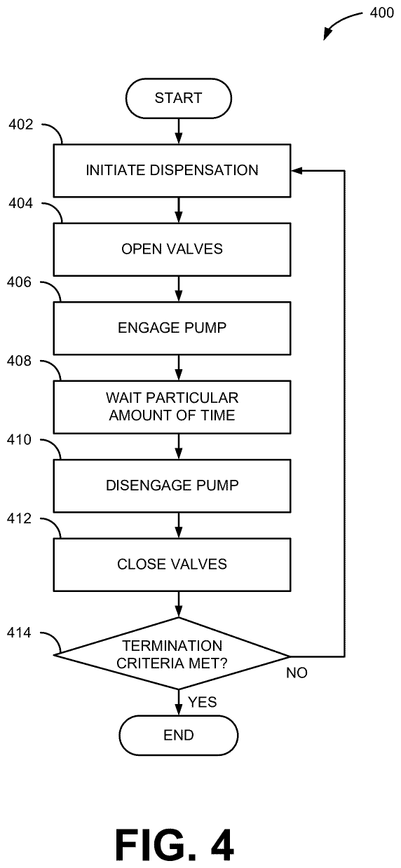

Referring now to FIG. 4, illustrated is a flowchart of a process 400. The beverage dispensing system 110 may include a leak resolution process 400. The leak resolution process 400 may define a technique for resolving a detected leak by inducing a series of rapid engagements of a dispensation system (e.g., the valve 128 and the beverage pump 124). In some embodiments both the valve 128 and the beverage pump 124 are engaged, while in others, only one of the two is engaged. The process 400 may function as a leak resolution procedure by rapidly pulsing the valve 128 and the beverage pump 124 in open/closed and on/off states, respectively. For example, when the computing system 140 detects a leak in the beverage dispensing system 110, the leak typically may stem from a loose seal within the one or more valves 128. Continuing this example, to reseat the seal within the valve 128, the computing system 140 may rapidly pulse the valve in an opened and closed position and rapidly pulse the beverage pump 124 in an on-and-off state. The computing system 140 may switch the valve from an open state to a closed state and the beverage pump 124 from an on state to an off state simultaneously. The rapid speed of the liquid pumped by the beverage pump 124 and the sudden closer of the valve 128 may allow the liquid to function as a force that pushes the seal into place. The process 400 of using the momentum of the liquid to drive the seal into a proper seated position within the valve 128 may be repeated until the computing system 140 detects that the leak is resolved.

At box 402, the process 400 may include initiating a dispensation of a particular beverage. The computing system 140 may initiate a dispensation of a particular beverage. For example, the computing system 140 may receive a request to dispense a particular beverage from the user interface 112. In another example, the computing system 140 automatically initiates the dispensation of the particular liquid as a procedural step in setting up the beverage dispensing system 110 and prior to receiving a command to dispense a beverage from the user interface 112. In yet another example, the computing system 140 may automatically initiate dispensation of a particular liquid on determining that a particular leak is present in the beverage dispensing system 110.

At boxes 404 and 406, the process 400 may include opening the valves 128 and engaging the beverage pump 124. The computing system 140 may open the valves 128 and may engage the beverage pump 124. The beverage pump 124 may remain engaged and the valves 128 may remain open for a particular amount of time. For example, at box 408, the process 400 may include waiting a particular amount of time (e.g., 0.1 second) prior to disengaging the beverage pump 124 and closing the valves 128. The computing system 140 may generate a signal after 0.1 seconds to disengage the beverage pump 124 and close the valves 128. By waiting a short period of time and allowing the beverage pump 124 to pump a particular amount of liquid, the liquid may build momentum as it moves toward the valves 128.

At boxes 410 and 412, the process 400 may include disengaging the beverage pump 124 and closing the valves 128. The computing system 140 may disengage the beverage pump 124 and close the valves 128. As the liquid builds momentum and the computing system 140 closes the valves 128 and disengages the beverage pump 124, the liquid may contact the seal within the valves 128. The liquid may transfer its momentum into the seal, moving the seal and seating the seal within the particular valves 128.

At box 414, the process 400 may include determining if a termination criterion is met. The computing system 140 may determine if the termination criterion is met. The termination criterion of box 414 may be substantially similar to box 318 of the process 300. For example, the computing system 140 may confirm that the termination criterion is met if the pressure measured after reseating the seal with the valves 128 equates to the initial pressure P₀ measured prior to dispensation. If the computing system 140 determines that the termination criterion is not met, the computing system 140 may repeat the process 400.

The computing system 140 may include an alert service. The alert service may include a log. The log may be stored in a data store of the beverage dispensing system or remotely on one or more of the computing devices 160, server 170, and or database 180 for further processing. In another example, if the computing system 140 repeats the process 400 over a threshold number of times, the computing system 140 may generate a service request indicating that the process 400 was unable to resolve the leak in the beverage dispensing system 110.

The leak detection process 300 may be performed before or after the leak resolution process 400. If the leak detection process 300 is performed after the leak resolution process 400 and detects a leak, the leak resolution process 400 may be repeated. If the leak resolution process is repeated, and the leak detection process still detects a leak, the alert service may indicate a major defect requiring repair or replacement.

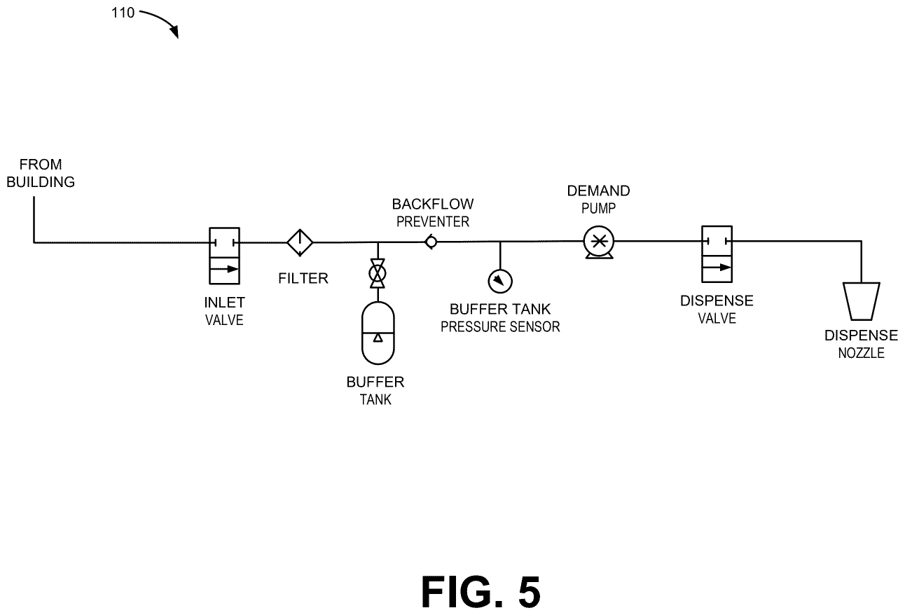

Referring now to FIG. 5, illustrated is an exemplary embodiment of the beverage dispensing system 110. In an exemplary embodiment, the system includes an inlet valve, upstream from a filter and a buffer tank. The buffer tank holds the liquid for beverage dispensation. Downstream from the buffer tank is a backflow preventer which regulates the direction of flow of the liquid. The system includes a buffer tank pressure sensor, upstream from a demand pump and a dispense valve which ultimately determines when and how much liquid is delivered to the dispense nozzle.

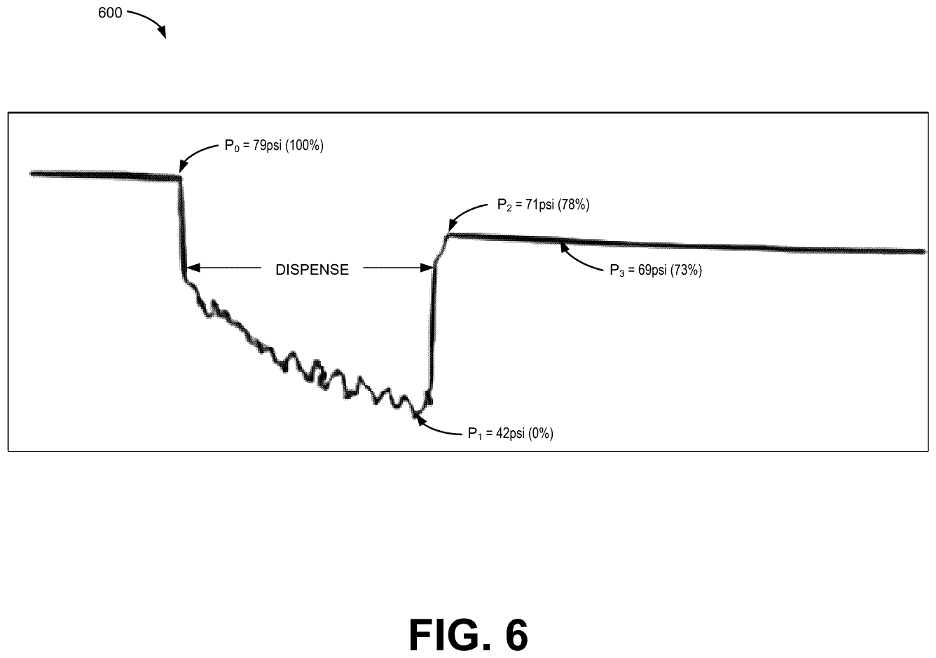

Referring now to FIG. 6, illustrated is an exemplary pressure profile 600 for a non-leaking beverage dispensing system 110 according to various aspects of the present disclosure. Under nonleaking conditions, it is clear that the pressure recovers following dispensation to a level of 78% of the pre-dispense.

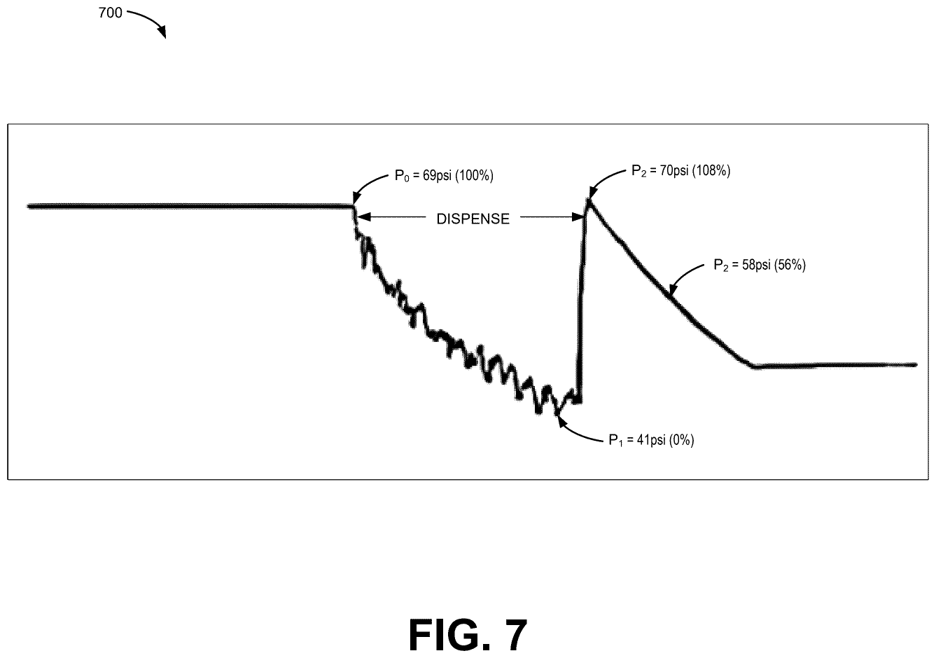

Referring now to FIG. 7, illustrated is an exemplary pressure profile 700 for a typical leaky beverage dispensing system 110. Under minor leak conditions, it is observable that the pressure recovers following dispensation, however it does not remain stable at a level near pre-dispense pressure, i.e., the pressure slowly decreases following the measurement.

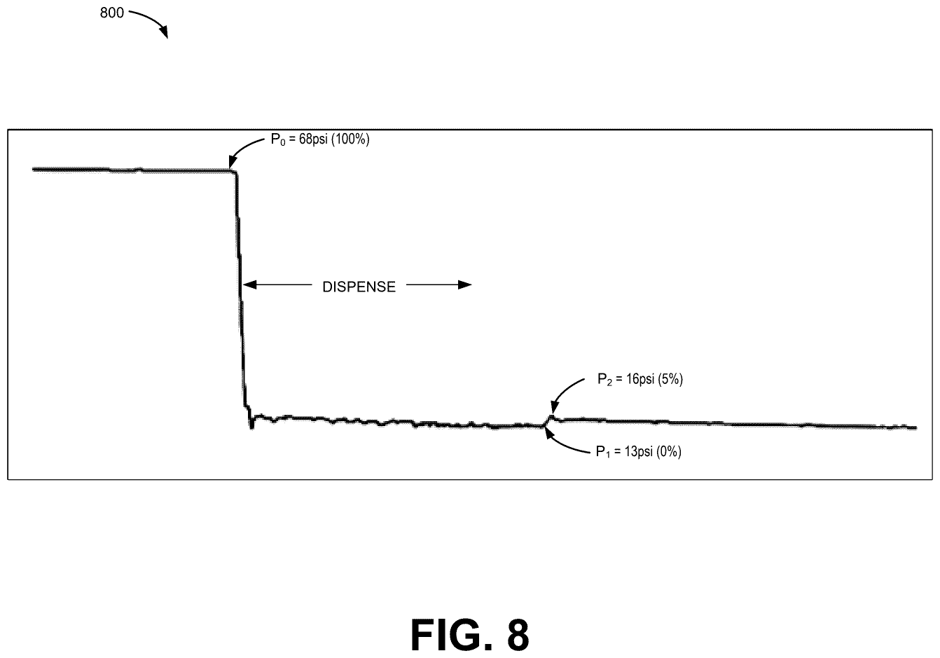

Referring now to FIG. 8, illustrated is an exemplary pressure profile 800 for a beverage dispensing system 110 exhibiting a major leak. Under major leak conditions, it is observable that the pressure entirely fails to recover following dispensation.

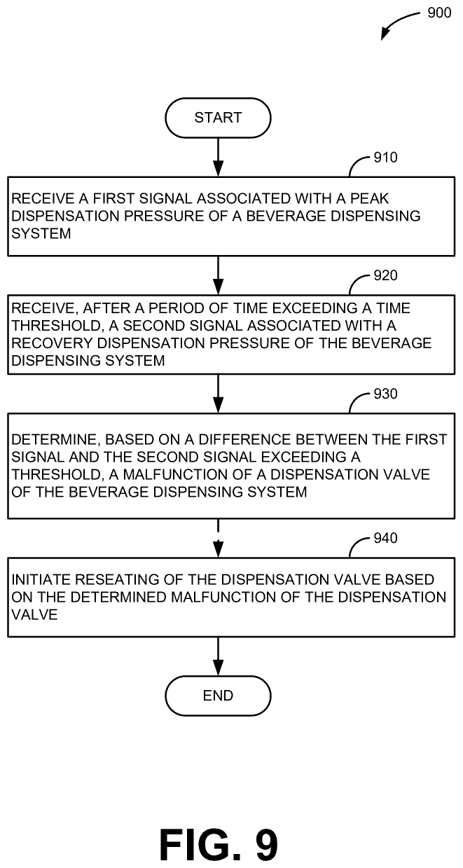

Referring now to FIG. 9, illustrated is a flowchart of a process 900 for leak detection and/or resolution in a beverage dispensing system (e.g., beverage dispensing system 110). At box 910, the process 900 may include receiving a first signal associated with a peak dispensation pressure of a beverage dispensing system. The peak dispensation pressure may be measured during a dispensation phase of the beverage dispensing system, e.g., at the point when the highest pressure is observed within the beverage dispensing system. According to some aspects, the first signal may be generated by one or more pressure sensors positioned strategically within the beverage dispensing system (e.g., upstream of the dispensation valve) to capture the pressure dynamics during operation of the beverage dispensing system. The peak pressure reading may serve as a reference point indicating performance of the beverage dispensing system under typical operational conditions.

The first signal may be continuously or intermittently monitored by the one or more computing devices that form part of the beverage dispensing system. The computing devices may process real-time data from the pressure sensors, analyze the characteristics of the peak pressure, and/or store this information for subsequent comparison with recovery pressure values. The peak pressure reading may allow the beverage dispensing system to determine whether a malfunction, such as a leak, is present based on deviations from expected pressure patterns. According to some aspects, the peak dispensation pressure may be analyzed in combination with a baseline pressure from the buffer tank or other components of the beverage dispensing system.

Moreover, the beverage dispensing system may refer to historical peak pressure values from previous dispensation cycles to account for fluctuations in system performance or environmental conditions. For example, effects of temperature variations, fluid viscosity changes, and/or type of beverage dispensed may be used to evaluate the peak pressure. For example, the beverage dispensing system may adjust enhance the accuracy of the leak detection process by comparing the current peak pressure reading to previous data.

At box 920, the process 900 may include receiving, after a period of time exceeding a time threshold, a second signal associated with a recovery dispensation pressure of the beverage dispensing system. For example, the beverage dispensing system may continuously monitor pressure over a set time period, ultimately receiving the second signal corresponding to the recovery dispensation pressure. Moreover, the recovery pressure may be measured after a period of time that exceeds a predefined time threshold to assess how well the pressure recovers after the beverage has been dispensed and the valves have closed. The recovery pressure may be used to determine whether the system returns to a stable state post-dispensation or if a pressure drop, indicating a potential leak, persists.

The time threshold for measuring the recovery pressure may be dynamically adjusted based on specific operating conditions of the beverage dispensing system. For example, different beverages may have different flow characteristics, which may influence how long it takes for the pressure to stabilize. The beverage dispensing system may employ real-time adjustments to align the time threshold with an expected recovery profile for a specific beverage being dispensed. If the recovery pressure does not return to within acceptable limits, this may be an indication of a system malfunction. In some aspects, the beverage dispensing system may correlate the recovery pressure signal with additional parameters, such as the rate of pressure decline or the duration it takes to reach the recovery pressure. These additional factors may be used by the beverage dispensing system to refine leak detection algorithms and/or provide more accurate diagnostics of performance of the dispensation valve.

At box 930, the process 900 may include determining, based on a difference between the first signal and the second signal exceeding a threshold, a malfunction of a dispensation valve of the beverage dispensing system. Specifically, the beverage dispensing system may calculate the difference between the first signal (e.g., peak dispensation pressure) and the second signal (e.g., recovery dispensation pressure) to assess whether the pressure drop exceeds a predetermined threshold. If the difference between the first signal and the second signal is greater than the threshold, the beverage dispensing system may conclude that a malfunction, such as a leak or incomplete valve closure, has likely occurred.

The determination of the malfunction may allow the beverage dispensing system to identify issues without requiring manual intervention. By automating the comparison between the peak and recovery pressures, the system may continuously monitor the health of the beverage dispensing system and provide real-time diagnostics. The threshold for detecting a malfunction may be dynamically adjusted based on factors such as beverage type, pressure profiles from previous dispensation events, and environmental conditions.

Moreover, the beverage dispensing system may classify a severity of the malfunction based on the magnitude of the pressure difference. For example, a minor malfunction may correspond to a small deviation between the peak and recovery pressures, while a major malfunction may be indicated by a significant pressure drop that requires immediate attention. The beverage dispensing system may tailor its response based on the classification of the malfunction, including initiating different levels of corrective actions depending on the severity of the issue.

According to some aspects, the beverage dispensing system may incorporate historical pressure data into the determination of the malfunction, e.g., using machine learning algorithms or other statistical methods to refine its predictions. By analyzing patterns in the pressure data over time, the beverage dispensing system may improve its ability to detect subtle issues before they escalate into major malfunctions.

At box 940, the process 900 may include initiating reseating of the dispensation valve based on the determined malfunction of the dispensation valve. Reseating of the dispensation valve may include modulating various components of the beverage dispensing system, such as the beverage pump or the valve itself, to force the valve back into its proper position and eliminate any leaks. The rescating process is typically automated, allowing the system to correct minor malfunctions without requiring manual intervention from an operator.

Moreover, the reseating of the dispensation valve may involve generating rapid pressure pulses within the beverage dispensing system to dislodge any debris or correct misalignments in the valve components. The pressure pulses may be generated by briefly activating the beverage pump or by opening and closing the valve in quick succession. By applying the pressure pulses, the beverage dispensing system may attempt to reestablish a proper seal in the valve, thus preventing further leaks.

According to some aspects, the rescating of the dispensation valve may be tailored to the specific characteristics of the detected malfunction. For example, if the beverage dispensing system determines that the malfunction is minor, it may initiate a gentle rescating process with lower pressure pulses. Conversely, for major malfunctions, the beverage dispensing system may apply more forceful pressure pulses or initiate additional diagnostic routines to ensure that the valve is fully reseated.

If the reseating process is successful, the beverage dispensing system may continue normal operation and resume monitoring for any future malfunctions. However, if the reseating process fails to resolve the issue, the beverage dispensing system may escalate its response by generating an alert for maintenance personnel or initiating a more comprehensive diagnostic process. This ability to automatically attempt leak resolution, combined with real-time monitoring and diagnostics, may significantly enhance the reliability and efficiency of the beverage dispensing system.

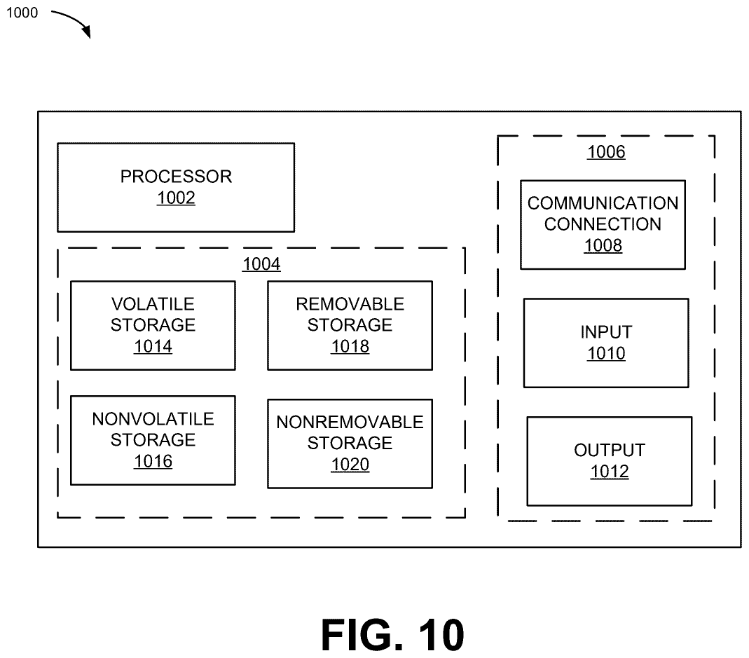

FIG. 10 is a block diagram of a computing device 1000 that may be connected to or comprise a component of environment 100. Computing device 1000 may comprise hardware or a combination of hardware and software. The functionality to detect and/or resolve leaks in a beverage dispensing system may reside in one or a combination of computing devices 1000. Computing device 1000 depicted in FIG. 10 may represent or perform functionality of an appropriate computing device 1000, or a combination of computing devices 1000, such as, for example, a component or various components of a beverage dispensing system, a computing device, a processor, a server, a gateway, a database, a firewall, a router, a switch, a modem, an encryption tool, a virtual private network (VPN), a network access control (NAC) device, a secure web gateway, or the like, or any appropriate combination thereof. It is emphasized that the block diagram depicted in FIG. 10 is exemplary and not intended to imply a limitation to a specific example or configuration. Thus, computing device 1000 may be implemented in a single device or multiple devices (e.g., single server or multiple servers, single gateway or multiple gateways, single controller or multiple controllers). Multiple network entities may be distributed or centrally located. Multiple network entities may communicate wirelessly, via hard wire, or any appropriate combination thereof.

Computing device 1000 may comprise a processor 1002 and a memory 1004 coupled to processor 1002. Memory 1004 may contain executable instructions that, when executed by processor 1002, cause processor 1002 to effectuate operations associated with a beverage dispensing system. As evident from the description herein, computing device 1000 is not to be construed as software per se.

In addition to processor 1002 and memory 1004, computing device 1000 may include an input/output system 1006. Processor 1002, memory 1004, and input/output system 1006 may be coupled together (coupling not shown in FIG. 10) to allow communications between them. Each portion of computing device 1000 may comprise circuitry for performing functions associated with each respective portion. Thus, each portion may comprise hardware, or a combination of hardware and software. Accordingly, each portion of computing device 1000 is not to be construed as software per se. Input/output system 1006 may be capable of receiving or providing information from or to a communications device or other network entities configured for detecting and/or resolving leaks in a beverage dispensing system. For example, input/output system 1006 may include a wireless communication (e.g., 3G/4G/5G/GPS) card. Input/output system 1006 may be capable of receiving or sending video information, audio information, control information, image information, data, or any combination thereof. Input/output system 1006 may be capable of transferring information with computing device 1000. In various configurations, input/output system 1006 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 1006 may comprise a Wi-Fi finder, a two-way GPS chipset or equivalent, or the like, or a combination thereof.

Input/output system 1006 of computing device 1000 also may contain a communication connection 1008 that allows computing device 1000 to communicate with other devices, network entities, or the like. Communication connection 1008 may comprise communication media. Communication media may embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 1006 also may include an input device 1010 such as keyboard, mouse, pen, voice input device, or touch input device. Input/output system 1006 may also include an output device 1012, such as a display, speakers, or a printer.

Processor 1002 may be capable of performing functions associated with detecting and/or resolving leaks in a beverage dispensing system, such as functions for a beverage dispensing system, as described herein. For example, processor 1002 may be capable of, in conjunction with any other portion of computing device 1000, leak detection and resolution in a manifold of a beverage dispensing system, as described herein.

Memory 1004 of computing device 1000 may comprise a storage medium having a concrete, tangible, physical structure. As is known, a signal does not have a concrete, tangible, physical structure. Memory 1004, as well as any computer-readable storage medium described herein, is not to be construed as a signal. Memory 1004, as well as any computer-readable storage medium described herein, is not to be construed as a transient signal. Memory 1004, as well as any computer-readable storage medium described herein, is not to be construed as a propagating signal. Memory 1004, as well as any computer-readable storage medium described herein, is to be construed as an article of manufacture.

Memory 1004 may store any information utilized in conjunction with a beverage dispensing system. Depending upon the exact configuration or type of processor, memory 1004 may include a volatile storage 1014 (such as some types of RAM), a nonvolatile storage 1016 (such as ROM, flash memory), or a combination thereof. Memory 1004 may include additional storage (e.g., a removable storage 1018 or a non-removable storage 1020) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by computing device 1000. Memory 1004 may comprise executable instructions that, when executed by processor 1002, cause processor 1002 to effectuate operations associated with document management.

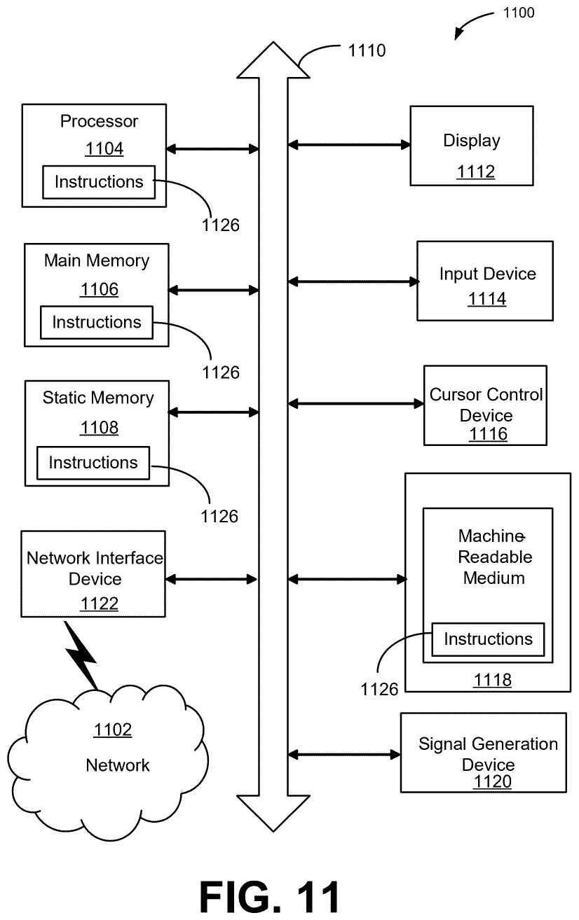

FIG. 11 depicts an exemplary diagrammatic representation of a machine in the form of a computer system 1100 within which a set of instructions, when executed, may cause the machine to perform any one or more of the methods described above. One or more instances of the machine can operate, for example, as processor 1002, user interface 112, computing system 140, computing device(s) 160, server 170, database 180, and other devices of FIGS. 1-10. In some examples, the machine may be connected (e.g., using a network 1102) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 1100 may include a processor (or controller) 1104 (e.g., a central processing unit (CPU)), a graphics processing unit (GPU, or both), a main memory 1106 and a static memory 1108, which communicate with each other via a bus 1110. The computer system 1100 may further include a display unit 1112 (e.g., a liquid crystal display (LCD), a flat panel, or a solid-state display). Computer system 1100 may include an input device 1114 (e.g., a keyboard), a cursor control device 1116 (e.g., a mouse), a disk drive unit 1118, a signal generation device 1120 (e.g., a speaker or remote control) and a network interface device 1122. In distributed environments, the examples described in the subject disclosure can be adapted to utilize multiple display units 1112 controlled by two or more computer systems 1100. In this configuration, presentations described by the subject disclosure may in part be shown in a first of display units 1112, while the remaining portion is presented in a second of display units 1112.

The disk drive unit 1118 may include a tangible computer-readable storage medium on which is stored one or more sets of instructions (e.g., instructions 1126) embodying any one or more of the methods or functions described herein, including those methods illustrated above. Instructions 1126 may also reside, completely or at least partially, within main memory 1106, static memory 1108, or within processor 1104 during execution thereof by the computer system 1100. Main memory 1106 and processor 1104 also may constitute tangible computer-readable storage media.

While examples of a system for leak detection and/or resolution in a beverage dispensing system have been described in connection with various computing devices/processors, the underlying concepts may be applied to any computing device, processor, or system capable of dispensing beverages. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer readable storage medium is not a propagating signal. A computer-readable storage medium as described herein is an article of manufacture. When the program code is loaded into and executed by a machine, such as a computer, the machine becomes a device for leak detection and/or resolution in a beverage dispensing system. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language and may be combined with hardware implementations.

The methods and devices associated with leak detection and/or resolution as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an erasable programmable read-only memory (EPROM), a gate array, a programmable logic device (PLD), a client computer, or the like, the machine becomes a device for implementing document management as described herein. When implemented on a general-purpose processor, the program code combines with the processor to provide a unique device that operates to invoke the functionality of a beverage dispensing system.

While the disclosed systems have been described in connection with the various examples of the various figures, it is to be understood that other similar implementations may be used, or modifications and additions may be made to the described examples of a beverage dispensing system without deviating therefrom. For example, one skilled in the art will recognize that leak detection and/or resolution as described in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

Aspects, features, and benefits of the systems, methods, processes, formulations, apparatuses, and products discussed herein will become apparent from the information disclosed in the exhibits and the other applications as incorporated by reference. Variations and modifications to the disclosed systems and methods may be effected without departing from the spirit and scope of the novel concepts of the disclosure. Any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the inventions to the precise forms disclosed. Many modifications and variations are possible in light of the above teaching.

The embodiments were chosen and described in order to explain the principles of the inventions and their practical application so as to enable others skilled in the art to utilize the inventions and various embodiments and with various modifications as are suited to the particular use contemplated. Alternative embodiments will become apparent to those skilled in the art to which the present inventions pertain without departing from their spirit and scope. Accordingly, the scope of the present inventions is defined by the appended claims rather than the foregoing description and the exemplary embodiments described therein.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media may be any available media which may be accessed by a computer, or downloadable through communication networks. By way of example, and not limitation, such computer-readable media may comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which may be used to carry or store computer program code in the form of computer-executable instructions or data structures and which may be accessed by a computer.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a computer to perform one specific function or a group of functions.

Those skilled in the art will understand the features and aspects of a suitable computing environment in which aspects of the disclosure may be implemented. Although not required, some of the embodiments of the claimed inventions may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed invention are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the inventions are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the invention is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed inventions will be readily discernible from the description herein, by those of ordinary skill in the art. Many embodiments and adaptations of the disclosure and claimed inventions other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed inventions. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed inventions. In addition, some steps may be carried out simultaneously, contemporaneously, or in synchronization with other steps.

The embodiments were chosen and described in order to explain the principles of the claimed inventions and their practical application so as to enable others skilled in the art to utilize the inventions and various embodiments and with various modifications as are suited to the particular use contemplated. Alternative embodiments will become apparent to those skilled in the art to which the claimed inventions pertain without departing from their spirit and scope. Accordingly, the scope of the claimed inventions is defined by the appended claims rather than the foregoing description and the exemplary embodiments described therein.

What is claimed is:

1. One or more computing devices, comprising one or more processors, configured to:
receive a first signal associated with a peak dispensation pressure of a beverage dispensing system;
receive, after a period of time exceeding a time threshold, a second signal associated with a recovery dispensation pressure of the beverage dispensing system; and
determine, based on a difference between the first signal and the second signal exceeding a threshold, a malfunction of a dispensation valve of the beverage dispensing system.

2. The one or more computing devices of claim 1, further configured to receive a baseline signal associated with a buffer pressure of buffer tank of the beverage dispensing system, wherein the difference between the first signal and the second signal is determined based on the baseline signal.

3. The one or more computing devices of claim 1, further configured to initiate reseating of the dispensation valve based on the determined malfunction of the dispensation valve.

4. The one or more computing devices of claim 3, wherein the reseating of the dispensation valve comprises modulating a pump of the beverage dispensing system.

5. The one or more computing devices of claim 1, further configured to determine a severity of the malfunction based on a magnitude of the difference between the first signal and the second signal.

6. The one or more computing devices of claim 5, wherein the severity of the malfunction is classified into at least two categories comprising a minor malfunction and a major malfunction.

7. The one or more computing devices of claim 1, further configured to transmit an alert to a remote server when the determined malfunction exceeds a malfunction threshold.

8. The one or more computing devices of claim 1, further configured to:
store historical pressure data associated with multiple dispensation events in a memory; and
adjust, based on the stored historical pressure data, the threshold for determining the malfunction.

9. The one or more computing devices of claim 1, further configured to initiate leak resolution based on the determined malfunction of the dispensation valve.

10. The one or more computing devices of claim 1, further configured to modify a flow rate of the beverage dispensing system in response to the determined malfunction of the dispensation valve.

11. The one or more computing devices of claim 1, wherein determining the malfunction of the dispensation valve is further based on comparing the second signal to a recovery pressure profile.

12. The one or more computing devices of claim 1, further configured to transmit an alert based on the determined malfunction of the dispensation valve.

13. The one or more computing devices of claim 1, wherein the time threshold is dynamically adjusted based on one or more operational parameters of the beverage dispensing system.

14. The one or more computing devices of claim 1, wherein the first signal and the second signal are received from a pressure sensor located upstream of the dispensation valve.

15. A method performed by one or more computing devices, the method comprising:
receiving a first signal associated with a peak dispensation pressure of a beverage dispensing system;
receiving, after a period of time exceeding a time threshold, a second signal associated with a recovery dispensation pressure of the beverage dispensing system; and
determining, based on a difference between the first signal and the second signal exceeding a threshold, a malfunction of a dispensation valve of the beverage dispensing system.

16. The method of claim 15, further comprising receiving a baseline signal associated with a buffer pressure of buffer tank of the beverage dispensing system, wherein the difference between the first signal and the second signal is determined based on the baseline signal.

17. The method of claim 15, further comprising to initiating reseating of the dispensation valve based on the determined malfunction of the dispensation valve.

18. A system comprising:
one or more processors; and
a memory coupled with the one or more processors, the memory storing executable instructions that when executed by the one or more processors cause the one or more processors to effectuate operations comprising:
receiving a first signal associated with a peak dispensation pressure of a beverage dispensing system;
receiving, after a period of time exceeding a time threshold, a second signal associated with a recovery dispensation pressure of the beverage dispensing system; and
determining, based on a difference between the first signal and the second signal exceeding a threshold, a malfunction of a dispensation valve of the beverage dispensing system.

19. The system of claim 18, wherein the operations further comprise receiving a baseline signal associated with a buffer pressure of buffer tank of the beverage dispensing system, wherein the difference between the first signal and the second signal is determined based on the baseline signal.

20. The system of claim 18, wherein the operations further comprise initiating rescating of the dispensation valve based on the determined malfunction of the dispensation valve.
